(19) United States
(12) Patent Application Publication
(10) Pub. No.: US 2014/0142977 A1
(43) Pub. Date: May 22, 2014

(54) SYSTEM FOR CHANGING PRESCRIPTIONS

(71) Applicant: Sudha Chinta, (US)

(72) Inventor: Sudha Chinta, (US)

(73) Assignee: Greatwater Software Inc., Windermere, FL (US)

(21) Appl. No.: 12/428,304

(22) Filed: Apr. 22, 2009

(51) Int. Cl. G06F 19/00

(52) U.S. Cl. CPC G06F 19/3462
USPC 705/3; 705/2

(57) ABSTRACT

A system is provided for changing prescriptions enabling collaboration of the patient and the provider to make the changes during an encounter. The system consists of a network of one or more kiosks or one or more touch screen mobile devices. The system works by enabling an electronic check-in for the patient, evaluating alternate prescription medication candidates during check-in, presenting any results found to the patient and to the provider to select one or more to implement during an encounter. The changes suggested can typically save costs. The changes may incorporate dosages and/or drugs that the patient may have better benefits and/or tolerance.

### REFERENCES CITED

1. “Methods and Systems for Prescription Review to Identify Substitutions”, U.S. Patent Application 2007/0226009 A1 Sep. 21, 2007

### SUMMARY OF THE INVENTION

Our invention consists of a system for changing prescriptions during a patient encounter with a provider. Our system consists of one or more kiosks or one or more touch screen mobile devices. The system checks in patients at a provider facility at one of these kiosk or mobile devices. When a patient interacts with the system for check-in, the system retrieves the patient's current medication list and medical record from one or more backend systems. It then searches and evaluates changes to one or more of the medications prescribed to the patient. The changes can include generic drugs or other brands of drugs or changes in dosage or changes in drug compounds that can be substituted for the specific patient's health situation or they may be from alternate sources such as a mail order pharmacy. Such changes may be motivated by the prospect of improved treatment or by cost savings. The alternates found are presented to the patient and to the provider who can collaboratively approve all, some or none of them. The approved changes can be converted into a prescription order with the system. Our invention provides automation to identify and make changes to prescriptions collaboratively between the patient and the provider during an encounter.

### BACKGROUND

Medications are expensive. In contrast to acute medical conditions that require medications until the disease subsides, chronic medical conditions such as diabetes, asthma, etc., require medications for an extended duration of time. The drug and dosage needs to be fine tuned to specific situation of the patient over time. There are significant differences in effectiveness and cost of different drugs from different manufacturers. There is a significant cost difference between supplying prescription medications from a retail pharmacy versus a mail order pharmacy, especially in the case of chronic conditions. There are significant cost differences between specific brands of drugs and also between generic drugs if available. The substitution of one drug with another equivalent drug needs to be performed by a qualified healthcare provider after evaluating the specific health situation of the patient. The cost difference between equivalent drugs adds up to a large amount over time for chronic diseases that require the patient to be on a prescription medications for extended periods of time. It is desirable to convert such a patient's prescription to lesser expensive drug to save costs. It is desirable to fine tune the medications for better treatment.

There is significant inertia to change a patient's prescription. The patient may not be aware of different prescription options for his/her medical condition. The provider may not get sufficient time to search for alternate medications that may provide better treatment and/or save costs. (We use the terms physician and provider interchangeably in this document and for our purpose we mean a person in the capacity to give prescriptions for medications to patients for the purpose of providing healthcare.) The situation gets even more complicated in the context of third party payors and pharmacy benefit management plans. The payor is financially motivated to change the prescription to save costs in the long term, but does not have the opportunity to participate in the interaction between the patient and the provider.

Our system enables the patient and the provider to evaluate and change prescriptions during an encounter.

### BRIEF DESCRIPTION OF THE DRAWINGS

FIG. 1 illustrates the preferred embodiment of our invention, where a patient walks up to a kiosk in our system to check-in.

FIG. 2 illustrates by means of a flow chart a process for finding alternate drugs and alternate sources for drugs based on current list of medications for the patient.

FIG. 3 illustrates by means of a flow chart the process for offering changes to prescriptions interactively to a patient at the time of check-in at a provider facility.

FIG. 4 illustrates by means of flow chart, the process of obtaining a consent .to the change.

FIG. 5 illustrates by means of a flow chart the process for presenting alternate drugs and alternate sources of drugs found to the provider for his/her approval and creating a prescription order.

### DETAILED DESCRIPTION OF THE PREFERRED EMBODIMENTS

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. The preferred embodiment of the invention will now be described with reference to the figures in which like numbers correspond to like references throughout.

In the preferred embodiment, the patient is checked in for an appointment at a provider office via kiosk. Software running in the kiosk first positively identifies the patient and displays his/her list of appointments for the day. Our invention implemented in the software then retrieves the current medication list and the health history for the patient from the practice management system or the electronic medical record or a prescription benefit management system. For each item on the medication list, a search/lookup of equivalent drugs for the given condition of the patient is performed and the retrieved list is sorted according to cost, drug to drug interaction, etc. The best alternates found are presented to the patient who then selects one or more or none of the suggested changes. (A signature of the patient consenting to the change or plurality of changes may be presented to the patient on the kiosk and his/her consent signature is obtained if needed.) The current medication list and the suggested changes for the prescriptions(s) for the current ailments are sent to the provider either by printing on paper or by electronic means. The status of various patients and their prescription changes are optionally summarized in a prescription activity monitor for the provider and/or the office staff. The patient walks through the list when he/she meets the provider and both together select the changes in prescriptions that the patient is willing to try. The provider gives a new prescription order reflecting the changes made. The prescription order is given to the patient either printed on physical paper or by electronic means.

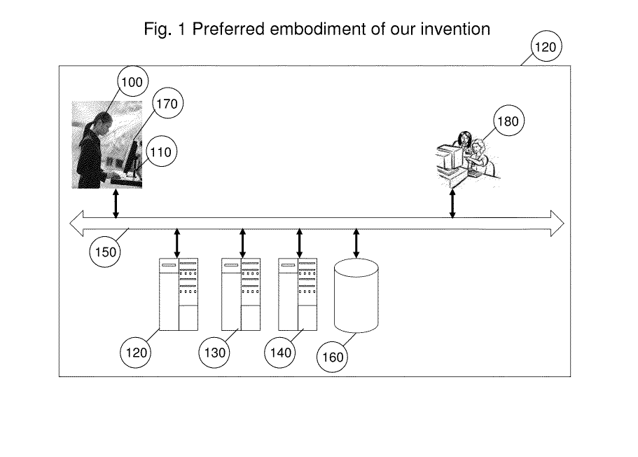

We illustrate the system of the preferred embodiment in FIG. 1. Patient 100 walks up to kiosk 110 in the physician office 120. The patient performs a check-in at kiosk 110. The kiosk looks up the patient and the patient's appointment if available in a back end scheduling system 120. After positively identifying the patient, the patient's current medication list is retrieved from the practice management system 130 or the electronic medical records system 140. The computer systems are connected by a computer network 150. The list of equivalent drugs for each medication is looked up in a drug database 160 (and/or electronic clearing houses, pharmacy benefits management systems and insurance company databases) and the results found are sorted and filtered by certain criteria such as cost, source, side effects, etc. Alternate choices for each medication are presented to the patient on the kiosk screen 170. The patient is prompted to select the medication changes that he or she likes. A complete list of current medications, a list of changes selected by the patient and a template prescription order for the changes is then printed and handed to the patient. The patient meets provider 180 and presents these documents to the provider to discuss the proposed changes and get his/her approval. The provider gives his approval by signing the printed prescription order. (The provider can choose to accept all changes, some of the changes or none of the changes. The provider can suggest other changes also.)

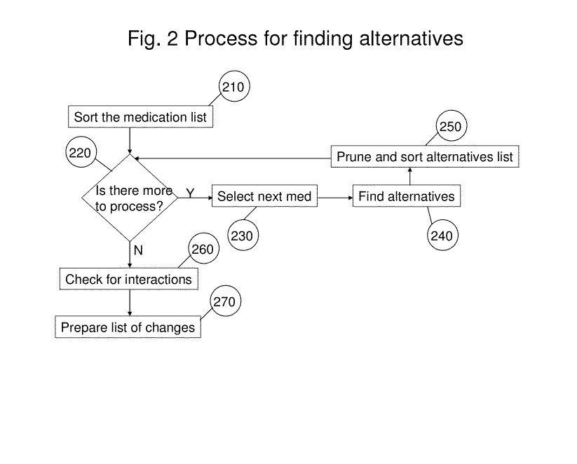

The process for finding alternatives is presented in FIG. 2. This may be implemented by means of a computer software program in the preferred embodiment. The algorithm starts with retrieving a list of current medications for the patient and sorting the list according to some criteria in step 210. For example the list may be sorted in the order of highest cost medication first. If there is another medication in the list to be processed in step 220, it is selected in step 230. The medication, dosage, the patient's medical condition, the patient's medical record, the patient's demographics etc. are used to search a drug database, a drug source database, etc., to find a list of alternatives in step 240. The alternatives could include generic drugs, different compounds, different dosages, alternate sources, etc. An interesting alternate source for chronic illnesses is the change from store pharmacy to a mail order pharmacy. The alternatives found are pruned and sorted according to certain criteria in step 250. Examples of pruning criteria include contraindications or drug/disease interactions. Examples of sorting criteria include cost or number of doses. The processing continues with the next medication in step 220. When all the medications have been processed, the alternates found are checked and marked for drug to drug interactions in step 260. The list of changes found is prepared in step 270 for further processing.

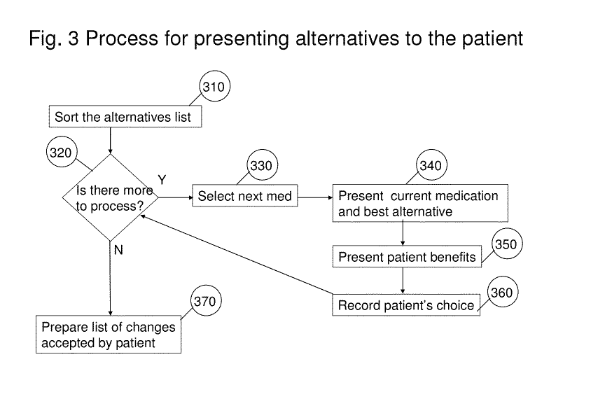

FIG. 3 illustrates by means of a flow chart the process of suggesting changes to the patient to the medication list and letting him or her choose among the alternatives found. We start in step 310 by sorting the alternatives list according to some criteria. An example of criteria is cost savings. We process the alternatives list in a loop in step 320. We select the next item on the list in step 330 and present the current medication versus alternatives found in step 340. For each alternative, the pros and cons found for the alternative are presented to the patient in step 350. The patient is interactively prompted to select the choice that he/she wants to make in step 360 and the processing of the list continues in step 320. Practitioners of the art can realize presenting several elements of the list at once depending on the screen size available for presentation in alternate embodiments. When the list processing is completed, the list of changes selected by the patient is prepared in step 370.

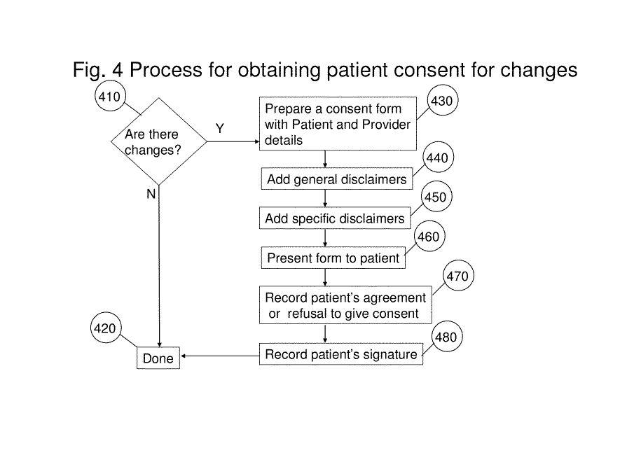

FIG. 4 illustrates by means of a flow chart the process of obtaining the patients consent for the changes made. We start in step 410 by checking if there are any changes made at all. If there are none, we are done in step 420. If there are changes made, a consent form is assembled in step 430. The general disclaimers are added in step 440. Specific disclaimers for each change are added in step 450. The entire consent form is presented to the patient is step 460, and the patients agreement to give consent to change(s) or refusal to consent with the change(s) is noted in step 470, along with a capture of signature in step 480. The process terminates in step 420.

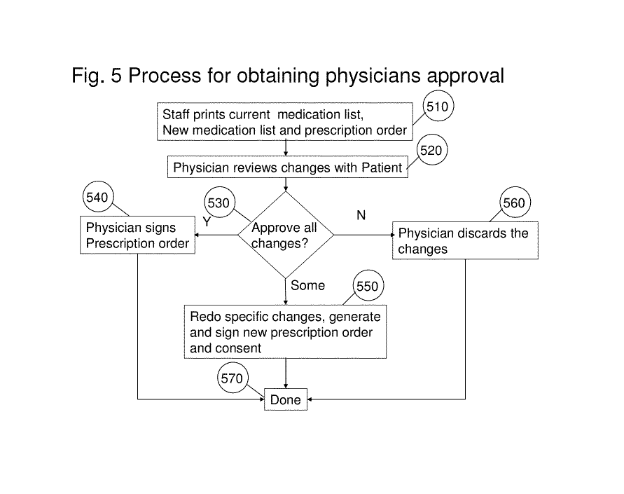

FIG. 5 illustrates by means of a flow chart the process of presenting the medication changes to the physician and converting the changes into a prescription order. In the preferred embodiment, the current medication list, the new medication list with changes marked and the prescription change order are all printed by the staff and added to the patient's record in the exam room in step 510. The physician reviews the changes in step 520. The physician has a choice of accepting all the changes, some of the changes or none of the changes in step 530. If the physician accepts all the changes, then he or she signs the new prescription order in step 540. Otherwise he or she can interactively select or input one or more changes together with the patient, get the patient's consent and sign the new change order in 550, similar to the process illustrated in FIG. 3 and FIG. 4. For each change made, the physician can optionally assess the benefit of switching a specific drug to mail order and if beneficial, can suggest and make the change in source. If the physician does not want to make any change, then the physician informs the patient of the decision and rejects the changes in step 560. All the branches in the flow chart terminate in step 570.

Practitioners of the art can realize that in a different embodiment, the current medication list, the change list and the new prescription order can be reviewed electronically by the physician on the display screen of a device instead of printing them on paper or in addition to printing them on paper. The system can be integrated with a prescription benefit management system and a pharmacy electronic order system, where the new prescription order can be submitted electronically instead of or in addition to printing it on paper. In yet another embodiment, the patient and the physician together review the current medications, the suggested changes and the new prescription order and accept or reject changes together. Newer technologies such as large touch screen displays, multiple displays or Microsoft Surface Units can be used by the patient and provider to review these items together. In yet another embodiment, our invention can be specifically targeted to patients with medications that can be cost effectively served from a mail order pharmacy rather than a retail store pharmacy. The system can be programmed to highlight the benefits and rewards of changing a prescription to mail order for a qualifying patient.

In a different embodiment, groups of medications from the current prescription list can be considered together as a set for change, and can be replaced by one new medication or a group of new medications.

We described specific embodiments of the invention along with specific examples in the specific domain of healthcare. Practitioners of the art can derive several embodiments and domains of applicability of our invention.

The illustrations, and block diagrams of FIGS. 1, 2, 3, 4 and 5 illustrate the architecture, functionality, and operation of possible implementations of apparatus, systems, methods and computer program products according to various embodiments of the present invention. In this regard, each block in the flow charts or block diagrams may represent a module, electronic component, segment, or portion of code, which comprises one or more executable instructions for implementing the specified function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

In the drawings and specification, there have been disclosed typical illustrative embodiments of the invention and, although specific terms are employed, they are used in a generic and descriptive sense only and not for purposes of limitation, the scope of the invention being set forth in the following claims.

### NOTE REGARDING CLAIMS

In the discussions contained in this Patent Application we have included many major elements which obviously are bases for claims and included several claims for this invention. In addition, as is customary practice, we will request that the Patent Examiner point out any resulting claims we may have inadvertently missed, and that he/she point out any relevant changes that should be made to clarify the submitted claims, and that he/she point out any unintended duplication of claims should such inadvertently occur.

1. A system for changing prescriptions during a patient encounter with a provider consisting of a check-in kiosk or several check-in kiosks or a mobile device or several mobile devices where the system identifies candidate prescription or prescriptions for change during check-in and enables the patient and the provider to collaboratively change the prescription or prescriptions if desired during the encounter.

2. A method of claim 1 where the patient's current medication list is retrieved from a backend electronic medical record, practice management system or pharmacy benefit management system and printed for the patient or the provider, or communicated electronically to the provider and/or patient at the time of check-in on a kiosk or a mobile device.

3. A method of claim 2 where changes to the current medication list are suggested to the patient at the time of check-in, electronically via a kiosk or via a mobile device held by the patient.

4. A method of claim 3 where the patient is enabled to select the changes that he or she agrees to, a patient consent is obtained if necessary, and a prescription order with the selected changes is presented to the provider during a later stage of the encounter, either by means of printing on a physical paper or by electronic means.

5. A method of claim 4 where the provider during the encounter with the patient reviews the suggested changes, selects the change or several changes that he or she approves and converts the changes into a prescription order for fulfillment.

6. A method of claim 5, where at least one of the changes suggested are motivated b_{y} cost savings to the patient or to the insurance company or to both or to other parties.

7. A method of claim 5, where at least one of the changes suggested is the substitution of one brand name drug by other brand name drug or a generic drug.

8. A method of claim 5, where at least one of the changes suggested is the change of source of a drug from a retail store pharmacy to a mail order pharmacy.

9. A method of claim 5, where at least one of the changes suggested is the change of one drug formulation to another drug formulation.

10. A method of claim 5, where cost savings from one or more changes is estimated and an offer is presented to the patient and/or the provider to prompt the change.

11. A method of claim 9, where at least of one of the changes is suggested because of feed back from the patient on low tolerance or due to side effects for a current medication or medications.

12. A method of claim 5, where a co-pay or patient portion of the obligation is collected for the change in prescription, at the time of change.

13. A method of claim 1, where during the patient check-in, a review of systems is conducted with the patient, data is obtained from electronic medical records, practice management systems or healthcare claims, where an assessment of whether the treatment provided or planned is compliant for the physician for payment by the insurance company, and any discrepancies found are corrected or notified to the physician.

14. A method of claim 3, where during the check-in process, the system finds and suggests a specific formulary that is compliant or a plurality of specific formularies that are compliant to the prescription benefit plan pertaining to the contract in effect between the payor, provider, patient and/or patient's employer.

15. A method of claim 3, where relevant medication information is presented to the patient electronically or by means of a printing on paper or both.

16. A method of claim 3, where the patient or one or more of the participants in the healthcare chain are incentivized to make a change or a plurality of changes in the prescription medication list

17. A method of claim 16, where the incentive is specifically offered for changing from a store pharmacy to a mail order pharmacy.

18. A method of claim 1, where the change is for goods such as injection needles, diabetes test strips, etc., in addition to or in place of prescription medications.

19. A method of claim 1, where a group of medications on the current prescription list of the patient are changed to a single new medication or a group of new medications.
